(19) United States
(12) Patent Application Publication
(10) Pub. No.: US 2017/0334635 A1
(43) Pub. Date: Nov. 23, 2017

(54) BEVERAGE CAPSULE, BEVERAGE PREPARATION SYSTEM AND METHOD FOR IDENTIFYING A BEVERAGE CAPSULE

(71) Applicant: Qbo Coffee GmbH, Wallisellen (CH)

(72) Inventor: Ivo Aschwanden, Zürich (CH)

(21) Appl. No.: 15/534,100

(22) PCT Filed: Dec. 8, 2015
(86) PCT No.: PCT/EP2015/078940

§ 371 Date: Jun. 8, 2017

(30) Foreign Application Priority Data
Dec. 11, 2014 (EP) 14197489.9

(51) Int. Cl. B65D 85/804; A47J 31/40; A47J 31/44; B65D 79/00

(52) U.S. Cl. CPC B65D 85/8043; B65D 79/00; A47J 31/407; A47J 31/4492

(57) ABSTRACT

A capsule for beverage preparations in a brewing machine, the capsule having a capsule container that is filled with an extraction product and has an essentially quadratic base, and a capsule cover that closes the capsule container. The capsule has at least one first optically readable code on the base of the capsule container, the code having a two-dimensional arrangement of several code elements, and at least one second optically readable on the base of the capsule container. The second code has a two-dimensional arrangement of several second code elements, which are arranged radially outside of the first code with respect to a center point of the first code. The invention also relates to a capsule and to an associated system including a brewing machine and to a method for identifying the type of capsule.

### BACKGROUND OF THE INVENTION

### Field of the Invention

The present invention relates to a drinks (beverage) capsule for creating a drink (beverage) from a drinks ingredient contained in the capsule. In particular, it relates to a drinks capsule, which includes a code, the code able to contain information on the drinks ingredient contained in the capsule or on other characteristics of the capsule, and being able to be decoded by a brewing machine. The invention moreover relates to a drinks (beverage) preparation system including a drinks capsule and a brewing machine, and to a method for identifying a drinks capsule in a brewing machine.

### Description of Related Art

Specifically, the present invention relates to a capsule for drinks preparation in a brewing machine, said capsule including a capsule beaker filled with a drinks ingredient and having an essentially square base, and a capsule cover, which is fastened on the capsule beaker. The capsule as a whole is thereby preferably essentially cubic, i.e. the lateral walls of the capsule, which connect the base and the cover have essentially the same square shape as the base and the cover. The lateral edge length, however, can also be larger or smaller, so that an essentially cuboid capsule then arises.

Capsules of this type are known from EP 2419352 A1, WO 2015/096989, WO 2105/096990 and WO 2015/096991, which are referred to here.

Individual portion capsules for preparing drinks, in particular hot drinks (beverages) such as coffee, tea, chocolate drinks or milks drinks are enjoying increasing popularity. Such drinks capsules typically include an extraction material, such as roasted or ground coffee or tea for example, or one or more soluble drinks ingredients such as instant coffee, milk powder or cocoa powder. Apart from these known ingredients, the term “extraction material” within the scope of the present invention is also to include a cleaning agent which can be utilised for cleaning a brewing machine.

It is already known to provide drinks capsules with a code which can be read out by the brewing machine and which, for example, contains information on the capsule type, on the drinks ingredient or on the optimal brewing parameters for the capsule concerned. Capsules on which a bar code is deposited on a cover membrane, amongst others are known, for example, from EP 2168073, and capsules on which a QR-code is printed, likewise on a cover membrane, are known from WO 2011/089048A1, for example.

It is indeed relatively simple to deposit a code on a cover membrane, which is to say on a capsule cover. The covers are often printed in any case and can be provided with a code with only little additionally effort. However, the reading-out of the code on the cover is difficult, particularly given a horizontal arrangement of the capsule in a brewing machine, with which the water is mostly introduced through the capsule base, and the brewed product exits through the cover membrane, which is to say through the cover and is led into the cup. A detection unit, which is provided in the brewing chamber at the side of the capsule cover, is therefore always exposed to a contamination by way of drinks residues, splashes, etc. Moreover, one typically wishes to keep the path between the exit of the drink out of the capsule and the cup as short as possible, and for this reason it is quite a challenge to be able to accommodate the detection unit at all. The solutions, which are described in EP 2168073 and in WO 2011/089048A1, are therefore not suitable for capsules, which are brewed in so-called horizontal brewing machines, i.e. in a horizontal alignment.

Further disadvantages of the state of the art lie in the applied codes themselves. The quantity and type of information that can be coded into a bar code is very limited.

QR-codes and similar, known 2-D codes, although being able to contain and code very much more information, however due to their structure are only suitable for the application on drinks capsules to a limited extent, if these are to be read out in brewing machines. A common problem on reading out a code provided on a capsule in a brewing machine, are specifically the contaminations that arise due to splashing of drinks, lime deposits and the like, and such contamination can occur on the read-out optics, as well as on the capsule itself, depending on the mounting of the capsules.

Common, optical 2-D codes include all so-called finder patterns, whose successful recognition is absolutely necessary in order to be able to read out the code. If a local contamination is now located right in the region of the finder pattern, then the complete code becomes unreadable. This then leads to an error notice, depending on the programming of the machine, and this demands a removal of the non-readable capsule. If such a problem cannot be overcome by way of cleaning the read-out optics or the capsule, then the capsule—which per se is consumable—must possibly even be thrown away, which is of course not acceptable from the customer's point of view. The demands upon the optics of the camera and on the computation capability of the processor of the detection unit in a brewing machine are difficult to meet with an acceptable effort with regard to cost and space, in the case of the known 2-D codes.

It is therefore an object of the present invention, to provide a capsule of the initially mentioned type, which is provided with a code, said code being able to store a sufficient quantity of information and being able to be read out in the brewing machine in a rapid manner and with an extremely high success rate. It is further an object of the invention, to provide a system of such a capsule and of a brewing machine, as well as a method for the identification of such a capsule, which overcome the mentioned disadvantages.

### SUMMARY OF THE INVENTION

This object is achieved by a capsule for drinks preparation, which is defined in the patent claims, by a system for preparing a drink from such a capsule as well as by a method for identifying such a capsule in a brewing machine.

According to the invention, at least one first optically readable code, which is for example visually and directly recognisable in the visible region and/or for example in the infrared region or possibly ultra-violet region by way of suitable aids (camera with a sensor sensitivity in the infrared region or the like), is formed on the base of the capsule beaker or provided on this. The first code includes a two-dimensional arrangement of several first code elements. A second optically readable code is further provided on the base of the capsule beaker. This also includes a two-dimensional arrangement of several second code elements. The second code elements, thus the second code lies radially outside the first code with respect to a middle point of the first code. The first code is preferably located in the centre of the base of the capsule beaker.

The first and the second code thereby represent different code levels. The code, which is deposited on the capsule base, in particular can be designed in a two-staged or multi-staged manner, wherein the first code defines a first code stage or a first code level, and wherein the second code defines a second code stage or a second code level.

Typically, the middle point of the two-dimensional first code coincides with the middle point of the base of capsule beaker. The first code typically includes a square or rectangular contour with side edges which run parallel to the side edges of the base of the capsule beaker. A rotated alignment of the first code relative to the geometry of the base of the capsule beaker however is also conceivable as an alternative. A differentiation of the codes is already possible alone by way of the position of these, due to the fact that the second code lies outside the first code. The first and second code can moreover be spatially separated from one another. It is conceivable for a code-free zone to extend on the base of the capsule beaker, between the first and the second code. The first and the second code are located at different distances to the middle point of the first code and/or to the middle point of the base of the capsule beaker due to the fact that the second code elements or the second code which is formed by these lie/lies radially outside the first code, which is to say radially outside all first code elements.

In particular, one envisages the capsule beaker with its base being able to be arranged in the brewing machine in total in four different orientations or alignments. The different alignments of the capsule result from a rotation of the capsule with respect to a middle point axis, which runs through the base and which typically extends perpendicularly to the plane of the base as well as perpendicularly to the plane of the capsule cover.

Attaching the code on the base of the capsule, and not on a cover, or, as described in the state of the art cited above, on a cover membrane, has various advantages. The capsule cover is therefore available for a decorative print, for information that can be read by the user, or the like, and the fashioning of the cover is not compromised by an additional code. However, supplementarily or alternatively to a printing of the capsule cover, one also does not rule out the base of the capsule beaker including further visually recognisable elements additionally to the code, for example decorative elements, an identifier or other information in a suitable form and which can be read out. In particular, the code can also be suitably integrated for example into a decorative element.

Moreover, due to the incorporation of the code on the base, a detection unit in a horizontal brewing machine can be arranged ahead of the brewing chamber, i.e. upstream of the brewing chamber, where there is less danger of contamination due to the splashing of drinks or the like and the installation space is less critical.

A detection unit with a camera is provided on the part of the brewing machine, for optically reading out or visually recognising the code on the base of the capsule beaker. The optical axis of the camera system advantageously coincides with the middle point of the first code when the capsule is located within the brewing machine in a read position. In this way and manner, the first code can be imaged in the picture middle of a picture recorded by the detection unit. The second code is then located radially outside the picture middle, roughly in an edge region of a recorded code picture.

The detection unit, in particular its camera as well as its picture recording sensor are advantageously designed particularly inexpensively and accordingly with a reduced performance. Inasmuch as this is concerned, it is conceivable for the radially outwardly lying second code to be able to be recorded, which is to say able to be read or detected with a reduced picture quality compared to the radially inwardly lying first code. Different code information can be stored in or on the base of the capsule beaker on account of the radially distanced positioning of first and second code elements or of first and second codes formed by these from. In particular, the second code can be designed as an optional code, which can only be recognised and processed by certain brewing machines.

According to a further embodiment, the second code completely surrounds the first code in the peripheral direction. The second code or its code elements, for example, can extend annularly around the outer edges of the first code. Thereby, it is moreover conceivable for the first code and the second code as a whole to have a square or rectangular structure or outer geometry. The first code can hereby lie completely within the second code. Here, however, an overlapping-free arrangement of the first and second codes or of the first and second code elements is envisaged. The first code is located within a continuous surface. The second code can also lie within a continuous and uninterrupted surface extending outside the first code.

The complete enclosure of the first code by the second code is advantageous for the in total four possible alignments of the code within the brewing machine. If, for whatever reason, the optical axis of the detection unit should not coincide exactly with the middle point of the first code, then approximately identical or similar images would however result on the detection unit in each of the four different possible alignments of the code.

It is further conceivable for a geometric middle point of the first code to coincide with a geometric middle point of the second code. Moreover, the middle points of the codes can also coincide with the geometric middle point of the base of the capsule beaker which is to say essentially to lie in a manner covering this.

According to a further embodiment, the first code elements and the second code elements are essentially identical. The codes can be differentiated solely by way of their position, for instance with respect to the middle point of the first code or with respect to a relative positioning to the edge of the base.

The use of identical first and second code elements is advantageous for the attachment of the code as well as for the picture evaluation which is arranged subsequently to the detection unit. The picture evaluation merely needs to recognise and identify a single pattern, which is characteristic of the first and second code elements, for recognising and reading out the code. With regard to hardware and software technology, this permits the use of particularly inexpensive, robust and durable hardware components. The recognition and use of a single code element for the first and the second code is moreover advantageous for reliable, rapid and error-free software recognition of code elements.

The arrangement of the first and of the second code in a manner spatially separated from one another permits a selective reading-out of the first and second codes. The spatially separated arrangement of different codes, which is graduated radially outwards, can moreover be used for different brewing machines. The second code can be used or ignored, depending on the design of the brewing machine. Optional additional information concerning the capsule and its extraction material can be rendered accessible for example via the second code only to a certain type or design variant of brewing machines. This can encourage the end-consumer to purchase such machines.

In contrast, it can be sufficient to only read out the first code, for particularly inexpensive brewing machines. Inasmuch as this is concerned, such machines can also be provided with an accordingly minimised detection unit and picture evaluation, which merely visually detect or decode the first code located in the central region of the base of the capsule beaker.

According to a further embodiment, at least one of the first and second code each includes a number of essentially identical and essentially identically aligned code elements. In particular, the first code can consist of a number of essentially identical and essentially identically aligned code elements. The same is also conceivable for the second code. The second code, considered per se, can also consist of a number of essentially identical and essentially identically aligned second code elements.

As an alternative to the design of the first and/or second code with identical and identically aligned code elements, one can also envisage the code elements within a code not being identical, by way of them systematically or non-systematically differing from one another in a characteristic. What is merely required is that they are recognisable as code elements, for example, by way of them having at least one certain predefined characteristics (minimum area, basic shape and alignment, etc.). Moreover, it can be necessary for the code elements of the first code and the code elements of the second code to systematically differ from one another with respect to at least one characteristic, for example by way of an alignment as described hereinafter, but also by way of a basic shape (L-shaped versus C-shaped or circular, etc.), a colouring, etc.

The first and second code elements can be essentially identical, so that one and the same picture recognition software or picture evaluation software can be used for the visual recognition of first and second codes.

According to a further embodiment however, one envisages the first code elements being aligned differently compared to the second code elements. Thereby, in particular one envisages all first code elements being designed in an essentially identical manner and being aligned essentially identically. The second code elements are also advantageously designed essentially identically as well as aligned essentially identically. The alignment of all first code elements however can differ from the alignment of the second code elements. The first and second code elements can be differentiated from one another solely by way of their alignment in this way and manner. The first and the second code can be directly recognised in the recorded picture of the base of the capsule beaker in this manner, and be evaluated separately.

According to a further development, one further envisages the first code and the second code containing different first and second code information. In particular, one envisages the first code including information with regard to the brewing procedure. For example, the first code includes a brewing program number as well as an unambiguous characterisation of the capsule or of its extraction material contained therein. Moreover, it is conceivable for the first code to also directly contain the information of relevance to the brewing procedure, such as various brewing parameters such as, for example, a water quantity, a water temperature, a water pressure, a brewing time or a pre-infusion time. The second code can include further additional information on the capsule or on the extraction material. The second code, for example, includes such information as a best-before date, a manufacturing or production location as well as a batch number.

The second code has a larger outer circumference than the first code due to the fact that the second code lies radially outside the first code and includes a continuous code surface. It can be necessary for the brewing machine or its detection unit to be provided with a larger picture sensor for the correct reading out and recognition of the second code. This machine or detection unit, for example, can be designed either exclusively only for reading out the first code and merely optionally also for reading out the second code, depending on the configuration of the brewing machine.

According to a further embodiment, at least one of the first and second code has a rectangular or square outer contour. In particular, it is conceivable for both, the first and the second code to each have a square or rectangular outer contour.

One can moreover envisage the outer edges of at least one of the first and second code extending essentially parallel to the outer edges of the base of the capsule beaker. Moreover, one can envisage line sections of first or second code elements running parallel to the outer edges of the code and/or parallel to the outer edges of the base of the capsule beaker. This contributes to a particularly clear imaging of the code elements at the pixel level of the detection unit.

According to a further embodiment, one envisages the first code elements of at least one of the first or second code including information, from which one of several possible alignments of the code or both codes in the plane of the base can be unambiguously derived. The code elements themselves typically have a two-dimensional design and have such a geometric contour which permits the alignment or orientation of the code elements in the plane of the base to be determined. The alignment of individual code elements hereby correlates to the alignment of the code formed by the code elements in each case. One of several possible alignments of the code can be determined in a reliable and unambiguous manner on the basis of a determining of the orientation of an arbitrary code element, due to the fact that preferably each code element has a defined alignment to the alignment of the code. The information concerning the orientation of the code in particular can be contained in each code element, so that it is at least the alignment of the code, which can be recognised without further ado, independently of the actual reading-out and decoding of the code.

The capsule of the known type can be inserted or introduced into the brewing machine in four different positions due to its symmetry and its square cross section. There are therefore four orientations for the capsule, each rotated by 90°, and thus also for the code, which is present on the base of the capsule. One of several possible orientations of the code can be unambiguously determined already by way of the recognition and identification of a single and arbitrary code element, due to the fact that the individual code elements carry information concerning the orientation of the code. The orientation of the code can therefore be determined in a robust manner via a majority decision on the basis of all determined orientations of code elements. If the arrangement of the code elements is selected in a manner such that they are located on an imagined grid structure forming the basis of the code, then the grid parameters can moreover be reconstructed by means of an arbitrary selection of code elements. The use of so-called finder patterns for a 2D code thus not only becomes superfluous, but moreover all the disadvantages, which are described above and which arise from a dirtied (contaminated) finder pattern, are advantageously avoided.

The use of finder patterns can be completely done away with due to the fact that the code elements provide coded information by way of their shape, their alignment in the plane and their surfaced distribution in the plane. The robustness of the code, particularly with regard to local contamination can be improved inasmuch as this is concerned.

With regard to the code elements, it is particularly the case that they do not have or define a rotationally symmetrical geometric structure, but rather an unambiguous, in each case imagined pointer structure which is unambiguous, at least for the several possible alignments of the code in the brewing machine, i.e. for different alignments in the plane of the base.

The information for the code orientation and which is required for a decoding and reading-out of the code can be decoupled from the decoding of the code and be determined independently of this, due to the coupling of the code alignment with the alignment of its individual code elements, which is envisaged here. This can have an advantageous effect on the realisation of as low and as inexpensive as possible technical demands on the optical detection unit and on a subsequently connected picture evaluation.

The determining of one of several possible alignments of the code relative to a detection unit of the brewing machine can be effected on the basis of at least one code elements and its alignment in the plane of the base or its alignment in a picture plane of a detection unit. The determining of the alignment of the code is thus independent of the arrangement of several code elements relative to one another.

In particular, the alignment of the code in the plane of the base is contained in each code element, so that the information concerning the alignment and orientation of the capsule relative to the detection unit of the brewing machine is redundantly contained in the code. This also applies to the grid parameters forming the basis of the code. These are also redundantly coded over the complete surface.

According to a further embodiment, the code elements at least of one of the first and second code include at least two straight line sections that are adjacent to one another at a defined angle. Straight-lined line sections of the code elements can be detected in the detection unit in a particularly precise and simple manner. The detection unit in particular has a two-dimensional, regular arrangement of optical or light-sensitive sensors, which are typically to be indicated as detector pixels.

Line sections of the code elements, which run in a straight line, can be imaged in accordance with the geometrical arrangement of adjacent detector pixels of the detection unit in this way and manner. In this way and manner, even with a low number of detector pixels, consequently by way of a detection unit having only a comparatively low resolution, it is at least the alignment of the line sections of the code elements which can be precisely detected for the purpose of determining their alignment, but the position of individual code elements within the 2-D code can also be precisely detected.

According to a further development of this, one further envisages at least one line section of the first code elements running essentially parallel to the outer edges of the essentially rectangular or square code. The outer edges of the code can, but do not necessarily need to be designed in a manner in which they are optically or visually recognisable on the base of the capsule beaker. Moreover, it is conceivable for individual, outer-lying code elements to quasi virtually mark the outer edges of the rectangular or square code solely by way of their edge position. The parallel alignment at least of a line section to the outer edges of the code leads to a clearly recognisable code structure. In particular, possible, slight deviations from the several possible alignments of the code or capsule, which are defined by the brewing machine and which lie within a certain tolerance region, can be recognised by way of visually or optically recognisable outer edges and can be used for the numeric compensation of errors or for picture evaluation.

A parallel alignment of line sections or of code elements relative to the edge of the code is not absolutely necessary for the recognition of the code structure. The code structure can also be contained exclusively in the position of the code elements. Arbitrary, orientatable code elements, which can also be different in shape and size, can be used.

According to a further embodiment, at least one line section of the first code elements or second code elements runs essentially parallel to the outer edges of the square base. Thereby, in particular one envisages the outer edges of the code also running parallel to the outer edges of the square base. One can moreover envisage the possible alignments of the code in the plane of the base and/or the typically four conceivable alignments of the capsule in the brewing machine coinciding with vertically or horizontally running outer edges of the square base, which is to say horizontally or vertically running outer edges of the rectangular or square code. The detection unit and the picture evaluation, which is integrated into this or subsequently connected to this, inasmuch as this is concerned can be provided with one or two preferential directions (x, y), which run parallel to the outer edges of the square base or parallel, which is to say the outer edges of the rectangular or square code provided on the base.

Moreover, it is conceivable for at least the first code elements to consist exclusively of line sections that all run parallel to the outer edges of the code.

According to a further embodiment, the code elements, typically all code elements of the first and second code are lasered onto the base of the capsule beaker or lasered into the base. The deposition of the code elements, consequently of the complete code onto the outer side of the base or into the material of the base is effected by way of laser radiation. Hereby, in particular one can envisage the material of the base undergoing a colour change or texture change when being subjected to laser radiation at a certain defined wavelength region, so that the code elements, which are formed by way of this can be visually represented in a particularly high-contrast manner. Thereby, it does not necessarily need to be the case of a colour change, which is visible to the human eye. It is also conceivable for a change in the reflection characteristics and/or absorption characteristics concerning IR or UV radiation to be achieved by the laser, so that a code, which cannot be recognised by the naked eye, but by a detection unit using IR-light or UV light arises. It is further conceivable for the code elements to be realised as laser engraving on or in the base of the capsule beaker. For this reason, no printing methods or an attachment of print dyes, which such a method entails are necessary for the attachment of the code elements and of the code, on the base of the capsule beaker. The lasering of the code elements onto or into the base of the capsule beaker effects a particularly durable and robust coding of the capsule beaker and thus of the complete capsule.

According to a further embodiment, one envisages at least one of the first and second code including 50 to 400 individual code elements and preferably 70 to 100 individual code elements, wherein these code elements are arranged two-dimensionally and spatially distributed on the base of the capsule beaker. The individual code elements in particular are arranged to one another without any overlapping. Inasmuch as this is concerned, they are provided on the base of the capsule beaker in manner spaced from one another. In total 100 to 800 bits of information can be integrated into the base of the capsule beaker by way of the mentioned number of code elements. Hereby, in particular, one envisages a code element having an information content of 2 bits in each case. In particular, the information content of each and every code element is contained in the spatial position of the code element in the plane of the base.

According to a further embodiment, one moreover envisages at least one of the first code and of the second code being subdivided into a regular imagined arrangement of code fields which are grouped together at least in pairs into code groups. Thereby, within a code group, only a single code field is provided with a code element, whereas the remaining code fields of a code group remain free. If, for example, a code group consist of four code fields, which are adjacent to one another, then four possible spaces are available for the code element. Such a code element can thus represent numbers from 1 to 4, consequently an information content of 2 bits. A code group in particular can include a two-dimensional arrangement of several code fields that are adjacent to one another. It is conceivable, for example, for a code group to consist of four code fields arranged in a square. However, other two-dimensional constellations, such as, for example, a rectangular code group, which, for example, consists of two horizontal rows each with three code fields, are also conceivable.

According to a further embodiment of this, the local position of a code element within the code group includes information. The total information content of a code group is directly dependent on the number of code elements belonging to the code group. If the code group includes four individual code fields, for example, then each code field per definition can represent a single piece of information, for example a number “0, 1, 2, 3 . . . ”. It is that code field and the value assigned to it which are selected by way of positioning a code element in this single code field of a code group.

The regular subdivision of the code into code fields and the occupancy of a code group formed from code fields, in each case by only a single code element lead to the respective code, with regard to the subdivision into code groups, having a homogeneous density of code elements over the surface of the code. Inasmuch this is concerned, the presence of a homogeneous information density can represent a plausibility or test criterion already on the picture level of the code, by way of which criterion read errors are recognised, the errors, e.g., being able to be caused by way of contamination and can erroneously be interpreted by the detection unit and/or a subsequently connected control as code elements. The position of individual or several code elements amongst one another can also represent a test criterion or plausibility criterion in the same way and manner.

According to a further embodiment, several code groups and/or code fields are brought together into a code word. The number of code groups and code fields in a code word can be selected in an arbitrary manner. Typically, each code word has an identical number of code elements or an identical number of code groups. For the division into code words, one can envisage each code word consisting of an integer number of code groups. Moreover, it is conceivable for a code word to include for example one or more code groups as well as individual code fields. In particular, a code word can have an odd multiple of code fields.

In particular, several plausibility and/or quality tests can be implemented on different code levels. It is conceivable for a first test to be effected with regard to a defined geometric shape of individual code elements. If, for example, a code element having a geometric structure differing from a predefined, for example L-shaped geometry is read out, then already this can led to a rejection or a correct recognition of the code.

The implementation of a further test criterion or quality criterion is also possible on a further, for example second code level. For example here, on the picture level, one can directly examine whether an envisaged number of code elements is located within a predefined surface segment of the plane. Thus, e.g., an integrity test can be carried out at the level of each or individual code groups or code fields. E.g., one can examine whether a code group includes precisely one code element in each case. The test criterion is not fulfilled if several or less than one code element is present per code group. To the same extent, this can then serve for the correct recognition of the code or one which is to be corrected.

Finally, it is also conceivable to also carry out a plausibility test on the level of individual or several code words. Thus, in particular individual test bits contained in code words can be selectively read and evaluated for the plausibility control. A complete decoding of the code is not necessary for all plausibility or quality tests which have been described above.

Basically, only a certain share of code fields, code groups or code words needs to be able to be read for a decoding. The plausibility tests and quality assessments of code elements, code fields, code groups and code words can then be used in order to make a good selection, and the reliability of the available information can be included in the decoding process when decoding. In particular, all decoding possibilities resulting in a given situation can be compared to one another. A decision concerning the coded content can then be made with a certain probability or trustworthiness by way of the quality assessment of the respectively determined decoding possibilities.

Moreover, the quality of the code, i.e. its recognisability can be determined several times and thus to a quite reliable extent, due to the possibility of a code testing or quality determining on the level of the code elements, on the level of the code fields or code groups and/or on the level of the code words. In particular, the quality of the code recognition can be assessed on each of these levels.

Independently of this, it is generally conceivable for an assessment of the quality of recorded codes on the picture level to be included in the computation of a grid as well as in the computation of one or more grid constants forming the basis of the code.

Thus for the code recognition, in particular one can envisage a grid or a grid constant of the code being determined by approximation, in particular by way of so-called fitting, in order to carry out a scaling of the recorded code inasmuch as this is concerned. The quality of the code, which is determined on the picture level, can also be used for this scaling, but also for the positioning of a grid. The decoding of the code itself can be effected or simplified by way of the quality recognition, too. Since the code is contained redundantly and several times, for example in each code word, then on the basis of a quality determining of all code words, it is those words, which amongst all code words have the highest quality or highest assessment, which are selected for decoding the code. Decoding errors can be minimised to a high degree in this way and manner.

Should the decoding on the basis of those words with the highest quality assessment not be possible or not provide a plausible result, one then envisages changing the grid constant and/or the grid position and carrying out the assessment and decoding afresh.

According to a further aspect, the invention moreover relates to a system for preparing a drink from a previously described capsule. The system includes a brewing machine with a brewing chamber for receiving a capsule of the above mentioned type, the capsule having an essentially square base, for the purpose of preparing a brewed drink, as well as with an optical detection unit for reading out a code from the base of the capsule beaker whilst the capsule is located in a read position above the brewing chamber. Thereby, the detection unit is designed such that it recognises the first code elements of the first code independently of the second code elements of the second code and decodes and/or evaluates these independently of one another, wherein the second code elements lie radially outside the first code with respect to a middle point of the first code. At least one corresponding capsule with a square base carrying the code also belongs to the system, wherein the code includes the first and second code elements, which are recognised by the detection unit.

According to a further aspect, the invention moreover relates to a method for identifying a capsule with a capsule beaker, which has an essentially square base and with a code with a two-dimensional arrangement of several code elements on the base, in a brewing machine for preparing a drink. The method hereby includes the following steps:
transferring the capsule inserted into the brewing machine by the user, into a read position,
recognising first code elements of a first code and recognising second code elements of a second code, wherein the second code elements lie radially outside the first code with respect to a middle point of the first code,
separately decoding first and second codes for the identification of the capsule type on the basis of information contained in at least one of the first and second code.

Different information can be recognised directly on the picture level by way of different codes, and be read out and decoded in a separate manner and in accordance with the requirements, in this way and manner. Such a graduated coding of the capsule is suitable and indeed envisaged in particular for different types of brewing machines.

It is generally the case that all features and advantages, which are described in the context of the capsule, apply to the same extent to the system and to the method described here, and vice-versa.

The term essentially identical or essentially identically aligned code elements, which is demanded in embodiments of the invention, is to express the fact that within the scope of the resolution accuracy of the detection unit and the subsequently connected picture evaluation the code elements are provided on the capsule base in a respectively identical and identically aligned manner. The detection unit and subsequently connected picture evaluation can provide a certain error tolerance, so that even slight, but also larger deviations from a defined geometry, position and/or defined alignment of the code elements can still be reliably detected.

Geometric deviations of the code elements with regard to their longitudinal or transverse extension of up to 10% or up to 20%, up to 30% or even up to 40% should hereby still fall within the tolerance region of the detection unit and thus still be valid as being essentially identical. In contrast, line or stripe thicknesses can differ from a predefined thickness by up to 200%. With regard to the alignment, deviations of 5%, up to 20°, 30° or even 35% can be tolerated, which is to say can be compensated, by the detection unit and the subsequently connected picture evaluation.

### BRIEF DESCRIPTION OF THE DRAWINGS

Embodiment examples of the invention are hereinafter described by way of figures. In the figures, the same reference numerals indicate the same or analogous elements. There are shown in:

FIG. 1 is a perspective view of a capsule for drinks preparation,

FIG. 2 is a lateral view of the capsule according FIG. 1,

FIG. 3 is a schematic representation of a brewing machine which is designed for receiving a capsule,

FIG. 4 is a schematic and simplified representation of a detection unit which is provided in the machine and is for visually detecting the code on the base of the capsule beaker,

FIG. 5 is a schematic representation of a first code which is provided on the base of the capsule beaker,

FIG. 6 is a simplified and schematic representation of a regular subdivision of the first code into individual code fields, code groups and code words,

FIG. 7 shows different positions of a code element in different code fields of a code group,

FIG. 8 is a simplified schematic representation of a base of the capsule beaker with a first and with a second code and

FIG. 9 is a schematic representation of two different code elements.

### DETAILED DESCRIPTION OF THE INVENTION

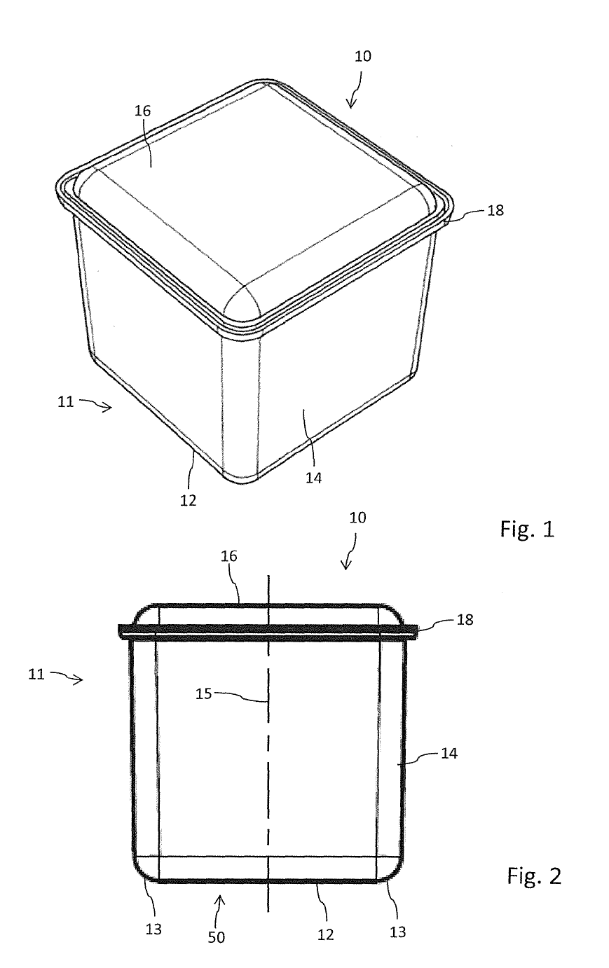

The capsule 10, which is represented in FIGS. 1 and 2, includes a pot-like capsule beaker 11 with a square capsule base 12. The capsule beaker 11 is away from the base 12 closed with a capsule cover 16 extending over the complete cross section of the capsule beaker 11. The capsule cover 16 and the side walls 14 of the capsule beaker 11 form an outwardly projecting flange section 18. The peripheral flange section 18 apart from a closure function, serves for mechanically coding the capsule. A receiver 21, which is provided on a brewing machine 20 and is typically in the form of an insertion or receiving shaft, can have a geometry corresponding to the outer contour of the capsule 10, which is represented in a lateral view in FIG. 2, so that the capsule can be introduced into the receiver of the brewing machine 20, compellingly in an orientation or alignment, in which the base 12 of the capsule beaker faces a detection unit 24.

Given a correct positioning of the capsule 10 in a read position L within the brewing machine 20, there are still four different possible orientations of the capsule 10 and of the optically readable or visually recognisable code 50 provided on the base 12, due to the square geometry of the base 12 of the capsule beaker 11 and of the essentially square, peripheral flange section. The different and several possible alignments of the code 50 are due to rotations of the capsule with respect to its imagined rotation axis 15, which extends essentially perpendicularly to the base 12 and perpendicularly to the capsule cover 16, and which in particular can coincide with a geometrical middle point of the base 12 and capsule cover 16.

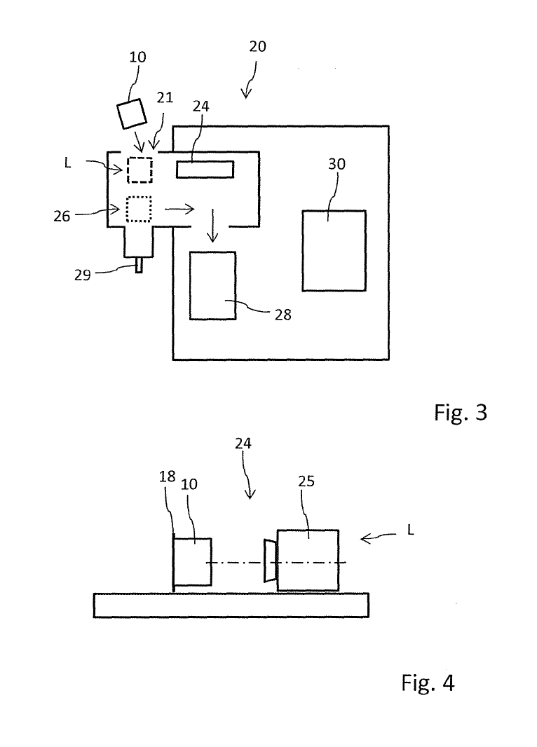

The brewing machine 20, which is shown in FIG. 3, is envisaged for receiving at least one capsule 10, which, by way of insertion into the receiver 21, can firstly be held in a read position L. In this read position L, the code 50 provided on the outer side of the base 12 of the capsule beaker 11 can be visually detected by way of the detection unit 24 and fed to a picture evaluation, by way of which picture evaluation the coded information can be decoded. A brewing chamber 26, in which the capsule 10 filled with the extraction product is at least partially perorated and the extraction material can be subjected to a fluid envisaged for the extraction procedure, in particular hot water, is located after the read position L. The extract, which is to say the drink, prepared in this way and manner can subsequently be collected via an outlet 29, in a drinks vessel, which is not explicitly shown. The spent capsule 10 can then be fed to a capture container 28 after the brewing procedure, and this container needs to be emptied now and again.

The brewing machine 20 is moreover provided with a control 30, which on the one hand is coupled to the detection unit 24 and on the other hand to the brewing chamber 26. A picture evaluation can either be contained in the detection unit 24 or in the control 30. The brewing procedure can be controlled, however at the minimum can be influenced, by reading out the code information of the capsule 10. The code 50, for example, can contain information concerning a preset brewing program, which can be automatically selected by the control 30 by way of the mere visual recognition of the code 50. The operating comfort of the brewing machine 20 can be increased and improved in this manner.

Moreover, by way of the provision of a code on the capsule, one can succeed in only original capsules provided by the manufacturer for the brewing machine 20 being able to be subjected to a brewing process. Product counterfeits as well as capsules 10, which, although having an outer geometry that is identical to that of the capsules shown in FIGS. 1 and 2, however do not have a code or a wrong code due to them not being envisaged for the brewing machine, can be recognised by the detection unit 24 or by the control 30, so that the initiation of the brewing process can be prevented.

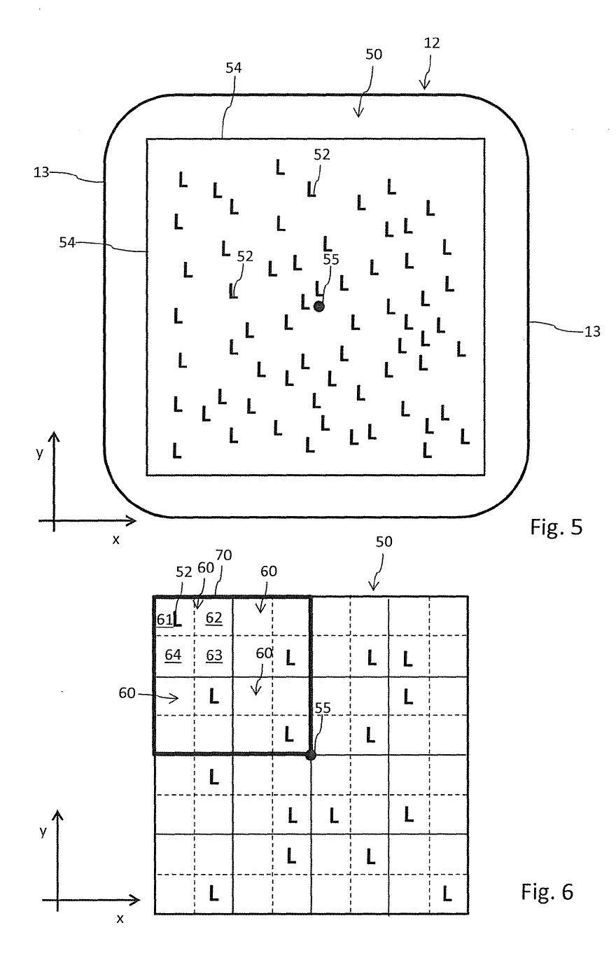

The detection unit 24 is represented in a simplified manner in the schematic representation according to FIG. 4. The detection unit 24 in particular includes a camera 25, which, with its optical axis typically and advantageously essentially coincides roughly with the middle point 55 of a first code 50 shown in FIGS. 5 and 6, as soon as the capsule 10 is located in the read position L within the brewing machine 20. A first code 50 on the base 12 of the capsule beaker 11 is represented schematically in FIG. 5. The first code 50 has an at least imagined middle point 55, which lies centrically or centrally within the outer edges 54 of the first code 50.

The first code 50 moreover includes a two-dimensional arrangement of several first code elements 52. Each of the first code elements 52 contains information, from which one of several possible alignments of the code 50 in the plane of the base 12 is unambiguously derivable. The code 50 can be arranged in total in four different alignments in the X-Y plane, which is represented in FIGS. 5 and 6 and which, for example, represents the picture plane of the detection unit 24 or coincides with this. The individual alignments can be assumed, for example, by way of a rotation of the capsule 10 in each case by 90° with respect to its rotation axis 15. The rotation axis 15 of the capsule beaker 11 can thereby coincide with the imagined middle point 55 of the first code 50.

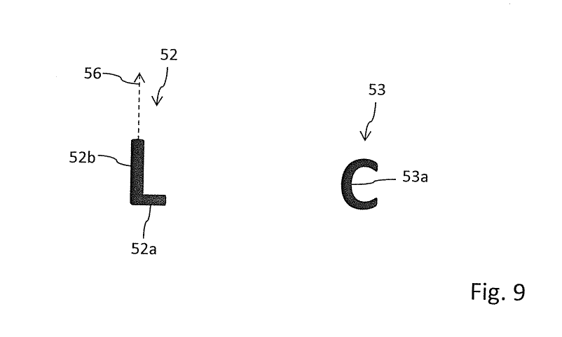

What can be recognised is that all first code elements 52 of the first code 50 are designed in an identical or essentially identical manner. They have an L-shaped contour with a first line section 52a, which extends horizontally in FIG. 5 and FIG. 9 and with a second, essentially vertically aligned line section 52b. With the alignment of the code 50 and of its individual code elements 52, which is represented in FIGS. 5 and 9, the intersection point of the line sections 52a, 52b lies at the bottom left. A short limb or the first line section 52a extends from the intersection point horizontally to the right, whereas the longer, i.e. the second line section 52b extends vertically upwards from the intersection point of the line sections 52a, 52b.

This arrangement and alignment of the individual line sections 52a 52b renders possible an unambiguous determining of the alignment of the associated code element 52 and of the code 50, which is formed by this. In particular, a pointer structure 56 can be unambiguously assigned to the code element 52. Here, for example a pointer structure 56 in the extension of the second line section 52b is shown in FIG. 9, wherein the pointer structure 56 points away from the intersection point of the two line sections 52a, 52b. On rotating the code 50 and its code elements 52, for example by 90° in the clockwise direction, a corresponding rotation of the line sections 52a, 52b as well of the associated pointer structure 56 results. This would then point horizontally to the right. The alignment or the orientation of the code 50 in the plane of the base 12, between the several possible alignments, can be determined comparatively simply as well as with a reduced effort concerning software and hardware technology, by way of determining the alignment of a single arbitrary code element 52, due to the fact that all code elements 52 are aligned essentially identically to one another and by way of the orientation of the code elements 52 being fixedly linked to the orientation of the code 50.

Hereby, it is particularly advantageous if at least one line section 52a, 52b of the first code elements 52 runs essentially parallel to the outer edges 13 of the square base 12 and/or essentially parallel to the outer edges 54 of the essentially rectangular or square code 50. Moreover, a right-angled arrangement of the differently long line sections 52a, 52b has been found to be advantageous for a particularly robust and precise position recognition of the code elements 52. The detection unit 24 in particular can include a regular, two-dimensional arrangement of several detector pixels, which can be arranged horizontally next to one another and vertically below one another, corresponding to the X-Y plane. Even with a low resolution of the detection unit or even with imaging errors, a picture recognition, which is adequate for determining the alignment of the code 50, can still be provided, due to the fact that the line sections 52a, 52b of the first code elements 52 are either aligned vertically or horizontally with respect to the X-axis and Y-axis respectively.

The use of L-shaped code elements 52 is only described by way of example and does not necessarily need to be provided. Basically, it is also conceivable to use other code elements 53, for example with a C-shaped basic geometry and with an arch section 53a, as is shown in FIG. 9. U-shaped, V-shaped or T-shaped code elements are conceivable to the same extent.

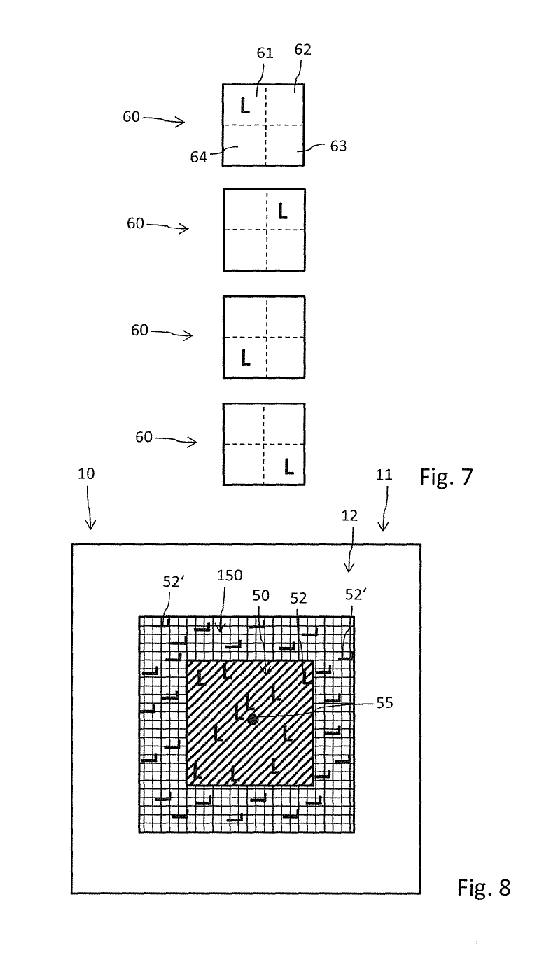

In FIG. 6, it is represented schematically as to how the first code 50 is subdivided into a regular imagined arrangement of code fields 61, 62, 63, 64, which at least in pairs are grouped into code groups 60. Hereby, only a single code field 61, 62, 63, 64 within a code group 60 is provided with a code element 52, whereas the remaining code fields 61, 62, 63, 64 of a code group 60 remain free of code elements 52. The different conceivable positions of a code element 52 in a code group 60, which is formed from in total four code fields 61, 62, 63, 64 is shown in FIG. 7. The four code groups 60, which are represented in FIG. 7, each represent one of four different conditions. Inasmuch as this is concerned, a code group 60, which is formed from in total four code fields, represents information of in total 2 bits (2²=4).

The rule, according to which each code group 60 is provided with only a single code element 52 has the effect that the surface density of first code elements 52 normalised onto the surface area size of the code groups 60 is constant over the entire surface of the first code 50. Moreover, each arbitrary surface segment of the first code 50 which has an integer number of code groups has an identical density of information. Finally, the local position of a code element within the code group is a carrier of the information concerned. The code information can be stored in the code by way of a single type of identical code elements 52, due to the fact that the code information is contained in the position of the individual code elements 52 relative to the code groups 60 or relative to the outer edge 54 of the code 50.

Moreover, one envisages a code group 60 including at least four code fields 61, 62, 63, 64 and, entailed by this, a minimum information with a 2 bit length. Moreover, several code groups 60 and/or several code fields 61, 62, 63, 64 can be grouped together into a code word 70. With the embodiment shown in FIG. 6, the code groups 60, which are provided in the left upper square of the code 50, are grouped together into a code word 70, which in total includes sixteen code fields 61, 62, 63, 64.

According to the requirement that a code group 60 is permitted to contain or include only a single code element 52, a first integrity test of the code 50 can be effected independently of a decoding of the code 50 and thus already directly on the basis of a recorded picture of the code 50. If, for example, the detection unit 24 recognises that more than one code element 52 is contained in several code fields 60, then this can directly be assessed as an indication that it is the case of a faulty or contaminated code 50 or of a counterfeit capsule. The number of code elements 52 within a code word 70 can be examined in the same way and manner.

Moreover, one envisages code information of the code 50 being redundantly contained in several code words 70. In this way and manner, it can be ensured that the code 50 and the code information contained in this can be read out in a reliable manner in the case of regional contamination in the region of the code 50 or of the detection unit 24. Thereby, in particular it is conceivable for the imaging and read-out quality of individual code words 70 to be determined, for example, by way of assigning and identifying individual code elements 52 to and with individual code words 70. If, for example, a demanded number of code elements 52 for the code word 70 should not be contained in a recorded picture, then this is an indication that the code word 70 concerned has been affected by contamination or is subject to an imaging error. Of the quantity of code words 70, it is typically only those which have a predefined number of code elements 52 which are selected for the decoding.

If not enough complete code words 70 are present for the decoding, then several estimations or assumptions to be considered can be made at the respective locations. Then, in the course of an integrity test of the code information subsequently resulting from the respective assumption and/or of the individual information bits, after decoding it can be decided whether the assumption was correct or not. Accordingly, a different assumption can also be made on the basis of the integrity test. This procedure can be repeated iteratively until the code information resulting from the made assumption fulfils the criteria of the integrity test.

Apart from the grouping of individual code groups 60, which is represented in FIG. 6, a code word 70 can basically also consist, for example, of one or more code groups and additionally of one or more code fields, so that the total number of code fields 61, 62, 63, 64 of a code word 70 is an odd numbered multiple of the number of code fields 61, 62, 63, 64 per code group 60. Hereby, it is conceivable for individual code fields 61, 62, 63, 64 to contain a type of test bit or test code, whereas the code words 70 are the carriers of the actual code information.

As is shown in FIG. 8, with the capsule 10 according to the invention, not only is a first code 50, but yet a second code 150 is provided on the base 12 of the capsule beaker 11 additionally to the first code 50. Whereas the first code 50 with its first code elements 52 is arranged roughly centrally or in a middle region of the base 12, the second code 150 with its second code elements 52′, with respect to the geometrical middle point of the first code 50 is located radially outside the first code 50. In the embodiment according to FIG. 8, the second code 150 completely encloses the first code 50 in the peripheral direction. The first and second code 50, 150 thereby each have a rectangular or square outer contour. In other words, the first code 50 is located within the second code 150.

The codes 50, 150 however are not designed in an overlapping manner. There are solely first code elements 52 belonging to the first code that are located exclusively in the region of the inner lying first code 50. The second code elements 52′ can be designed identically to the first code elements 52′. In this case however, one then envisages the first and second code elements 52, 52′ being aligned differently for the unambiguous and improved differentiation of the first and second code 50, 150. Here, all first code elements 52 are aligned in an essentially identical manner, whereas all second code elements 52′ are aligned in an essentially identical manner. In the embodiment example shown in FIG. 8, the orientation of the second code elements 52′ is rotated in the anticlockwise direction by 90° in comparison to the orientation of the first code elements 52.

However, differing from this, it is conceivable for example for the second code elements 52′ to have a geometry that is different to the L-shaped contour, for example a C-shaped contour or a U-shaped contour, which as such can be visually differentiated from the contour and geometry of the first code elements 52. For determining the alignment of the first and second code 50, 150, it is basically sufficient if only one of the first and second code elements 52, 52′ contains information, from which one of several possible alignments of the code 50, 150 in the plane of the base 12 can be unambiguously derived. Point-like or rotationally symmetrical code elements can basically also be used instead of rotated L-shaped second code elements 52′.

The first and second codes 50, 150 typically contain different code information. The first code 50 typically includes information provided for a brewing procedure, for example with regard to a brewing program, water quantity, brewing temperature, brewing pressure, brewing time or pre-infusion time, whereas the outer lying code 150, which is possibly only optionally to be used for certain brewing machines 20 contains further additional information concerning the extraction material, such as, for example, a sell-by-date, a production location, a location of origin or a batch number.

The different or the differently aligned code elements 52, 52′ permit a visual separation of the first and second code 50, 150, so that these can be detected, read out and decoded separately and independently of one another. The alignment of the second code elements 52′ relative to the outer edges 54 of the first code 50 or of the second code 150 as well as the arrangement of the second code elements 52′ amongst one another, in particular their arrangement in an at least imagined or virtual subdivision into code fields 61, 62, 63, 64, code groups 60 and code words 70 can be designed essentially identically as with the first code elements 52. The first code 50 as well as the second code 150 can be recognised, read out and decoded with one and the same picture evaluation in this way and manner.

The redundancy test here is selected in a manner such that the code information can be decoded already with a readability of 10% to 15% of the code surface. The code information is quasi uniformly distributed over the surface of the code 50 by way of the homogenous distribution of code groups 60 and code words 70 over the surface of the code 50. This renders the code 50 particularly robust given regional contamination or imaging errors

An integrity and plausibility test of code words 70 can be achieved directly on the bit level and on picture level due to the predefined constraint that a code group 60 formed from code fields 61, 62, 63, 64 includes exactly one code element 52. Moreover, a constant write time for the code 50 on the base 12 of the capsule beaker 11 can be achieved by the homogeneous distribution of the code elements within code groups. On writing or inscribing the base 12, by way of laser for instance, it is always the same number of code elements 52 which are written per unit of time.

It is even conceivable to carry out an integrity test of the code 50 or of the code words 70 or code groups 60, which are contained in the code 50, purely on the picture level. The better the integrity test is effected on the picture level, the less test bits are to be added to the code words 70. It is even conceivable to carry out an integrity test of the code 50 completely on the picture level, so that one can largely make do without test bits within the code 50.

### LIST OF REFERENCE NUMERALS

10 capsule
11 capsule beaker
12 base
13 outer edge
14 side wall
15 rotation axis
16 capsule cover
18 flange section
20 brewing machine
21 receiver
22 brewing unit
24 detection unit
25 camera
26 brewing chamber
28 capture container
29 outlet
30 control
50 code
52 code element
52′ code element
52a line section
52b line section
53 code element
53a arch section
54 outer edge
55 middle point
56 pointer structure
60 code group
61 code field
62 code field
63 code field
64 code field
70 code word
150 code

1. A capsule for drinks preparation in a brewing machine, wherein the capsule comprises a capsule beaker that is filled with an extraction material and has an essentially square base, and a capsule cover closing the capsule beaker, at least one first optically readable code is on the base of the capsule beaker, said code comprising a two-dimensional arrangement of several first code elements, and at least one second optically readable code is on the base of the capsule beaker, said second code comprising a two-dimensional arrangement of several second code elements that lie radially outside the first code with respect to a middle point of the first code.

2. The capsule according to claim 1, wherein the second code completely encloses the first code in the peripheral direction.

3. The capsule according to claim 1, wherein the first code elements and the second code elements are essentially identical.

4. The capsule according to claim 1, wherein at least one of the first and second code each comprises a number of essentially identical and essentially identically aligned code elements.

5. The capsule according to claim 1, wherein the first code elements are differently aligned in comparison to the second code elements.

6. The capsule according to claim 1, wherein the first code and the second code contain different first and second code information.

7. The capsule according to claim 1, wherein at least one of the first and second code has a rectangular or square outer contour.

8. The capsule according to claim 1, wherein the code elements at least of one of the first and second code each comprise information, from which one of several possible alignments of the respective code in a plane of the base can be unambiguously derived.

9. The capsule according to claim 1, wherein the code elements at least of one of the first and second code comprise at least two straight line sections that are adjacent to one another at a predefined angle.

10. The capsule according to claim 9, wherein at least one line section of the code elements runs essentially parallel to the outer edges of the first or second code and/or parallel to the outer edges of the square base.

11. The capsule according to claim 1, wherein the code elements are lasered onto the base of the capsule beaker or into the base.

12. The capsule according to claim 1, wherein at least one of the first and second ) code is subdivided into a regular, imagined arrangement of code fields, which at least in pairs are grouped into code groups, wherein only a single code field within a code group is provided with a code element.

13. The capsule according to claim 12, wherein the local position of a code element within the code group comprises information.

14. A system for preparing a drink from a capsule according to claim 1, comprising:
a brewing machine, comprising:
a brewing chamber for receiving a capsule with a capsule beaker with an essentially square base,
an optical detection unit for reading out the code on the base while the capsule is located in a read position above the brewing chamber,
wherein four different alignments of the capsule are possible in the read position, and the detection unit is designed in a manner such that it recognises the first code elements of the first code independently of the second code elements of the second code and decodes or evaluates these independently of one another, wherein the second code elements lie radially outside the first code with respect to a middle point of the first code,
the system further comprising a capsule with a square base carrying the code, wherein the code comprises the first and second code elements recognised by the detection unit.

15. A method for identifying a capsule with a capsule beaker that has an essentially square base and with a code with a two-dimensional arrangement of several code elements on the base, in a brewing machine for preparing a drink, the method comprising the steps of:
transferring the capsule inserted into the brewing machine by the user, into a read position,
recognising first code elements of a first code and recognising second code elements of a second code, wherein the second code elements lie radially outside the first code with respect to a middle point of the first code,
separately decoding first and second codes for the identification of the capsule type on the basis of information contained in at least one of the first and second code.
